(19) United States
(12) Patent Application Publication
(10) Pub. No.: US 2002/0073072 A1
(43) Pub. Date: Jun. 13, 2002

(54) Method of controlling access to database, database device, method of controlling access to resource, information processing device, program, and storage medium for the program

(76) Inventor: Keiji Fukumoto, Ikoma-gun (JP)

Correspondence Address: BIRCH STEWART KOLASCH & BIRCH, PO BOX 747, FALLS CHURCH, VA, 22040-0747, US

(21) Appl. No.: 10/013,714

(22) Filed: Dec. 13, 2001

(30) Foreign Application Priority Data
Dec. 13, 2000 (JP) 2000-379464

(51) Int. Cl. G06F 7/00

(52) U.S. Cl. 707/1

(57) ABSTRACT

A database device includes: data access permission setting manager for making a data access permission setting for a program which accesses a database storing sets of data for each of which a security level setting is made; and database access controller for controlling access to the sets of data in the database by the program by determining whether to allow or deny the program access to each of the sets of data based on the data access permission setting and the security level setting of that set of data when the program attempts to gain access to that set of data. Thus, the database device can take account of security and be flexible in controlling the access to the data in the database.

### FIELD OF THE INVENTION

The present invention relates to a database access control method of controlling access to a database by a program and a database device utilizing the method, as well as to a database access control method of controlling access to a resource by a program and an information processing device utilizing the method.

### BACKGROUND OF THE INVENTION

Conventionally, software programs (hereinafter, will be referred to as programs) are typically installed in a computer from a CD-ROM or by downloading them from a server.

However, these conventional methods unconditionally install the externally provided program in a computer and entails possible installation of a malicious program. If such a program is actually installed, the computer may allow access to important data without user's knowledge or otherwise cause serious security problems.

In order to solve the problems, U.S. Pat. No. 5,825,877 (registered on Oct. 20, 1998) discloses a method of preparing a control list for resources accessed by programs in advance to have a third party verify their safety so as to enable rejection of the installation of non-verified programs and also of allowing the user to further limit resources available for access by a verified program based on the control list for resources.

Japanese Published Patent Application No. 10-254783 (Tokukaihei 10-254783; published on Sep. 25, 1998) discloses a method of inspecting a program or a file associated to the program and defining accessibility to system level resources for the program, so as to enable suspension of execution of the program when the program attempts to gain access to a system level resource which exceeds the defined system level accessibility.

However, according to the method disclosed in the U.S. Patent, a third party verification is essential. Even a safe program cannot be executed unless its safety is verified. Further, a control list for accessed resources needs be prepared and added to each program in advance. This adds to complexity in the program development process.

According to the method disclosed in the Japanese Published Patent Application above, no certification is essential to a program to be installed. Nevertheless, a program needs be checked as to suitability, and the definition of system level accessibility is called for, before execution, which adds to complexity in the process.

Furthermore, either of the methods controls access resource by resource and cannot control access to each resource elaborately. For example, when the resource is a database, the program is either allowed full access to the database or completely denied access to the database.

### SUMMARY OF THE INVENTION

An objective of the present invention is to offer a database access control method and database device which take security into account to be flexible in controlling access to a database by a program. Another objective of the invention is to offer a resource access control method and information processing device which is capable of readily controlling access to a resource by a program.

To achieve the objective, a database access control method in accordance with the present invention is a database access control method of controlling access to a database in a database device executing a program which accesses a database and includes the steps of:

(a) making a data access permission setting for the program which accesses the database storing sets of data for each of which a security level setting is made; and

(b) controlling access to the sets of data in the database by the program by determining whether to allow or deny the program access to each of the sets of data based on the data access permission setting and the security level setting of that set of data when the program attempts to gain access to that set of data in the database.

A database device in accordance with the present invention includes:

data access permission setting manager for making a data access permission setting for a program which accesses a database storing sets of data for each of which a security level setting is made; and

database access controller for controlling access to the sets of data in the database by the program by determining whether to allow or deny the program access to each of the sets of data based on the data access permission setting and the security level setting of that set of data when the program attempts to gain access to that set of data in the database.

According to the method and configuration, the database in the database device includes security level settings each assigned to a different set of data, and the program executed by the database device to access the database has a data access permission setting with respect to the database. When the program attempts to gain access to a set of data in the database, the database device compares the security level setting of the set of data with the data access permission setting of the program to determine whether to allow or deny the access and thereby control access to the data by the program.

Hence, the access to the database by the program can be controlled differently for every set of data. Therefore, no control list of data access by the program needs be made and affixed to the program in advance.

Thus, the access to the database by the program can be controlled flexibly according to the security level setting of the set of data. Access is denied altogether in conventional cases if the database is overall given a high security level setting because of an important set of data stored therein; however, under the same circumstances, access is not denied in the invention if the program only needs to access a set of data of a low security level setting. In this manner, the database is better utilized as a result of enabling different control of access by the program for each set of data in the database.

To achieve the objective, a resource access control method in accordance with the present invention is a resource access control method of controlling access to a resource in an information processing device executing a program which access a resource in the device and includes the steps of:

(a) checking a data access permission setting of the program with respect to a database;

(b) making a resource access privilege setting for the program with respect to the resource based on a result of step (a); and

(c) controlling access to the resource by the program by determining whether to allow or deny the program access to the resource based on the resource access privilege setting when the program attempts to gain access to the resource.

An information processing device in accordance with the present invention is an information processing device for executing a program which accesses a resource in the device and includes:

data access permission checker for checking a data access permission setting of the program with respect to a database;

resource access privilege setting manager for making a resource access privilege setting for the program with respect to the resource based on a result of the checking; and

resource access controller for controlling access to the resource by the program by determining whether to allow or deny the program access to the resource based on the resource access privilege setting when the program attempts to gain access to the resource.

According to the method and configuration, the resource access program executed by the information processing device is assigned a resource access privilege setting with respect to the resource. When the program attempts to gain access to a resource, the information processing device checks the resource access privilege setting to determine whether to allow or deny the access and thereby control access to the resource by the program. In the information processing device, the program is assigned a data access permission setting with respect to the database and assigned a resource access privilege setting based on the data access permission setting.

Hence, the resource access privilege setting with respect to the resource can be assigned to the program based on the data access permission setting which is determined according to the safety level of the program with respect to the database. Therefore, the resource access privilege can be set relatively high for a program of which a high level of safety is confirmed with respect to the database and relatively low for a program of which a low level of safety is confirmed with respect to the database. A program of which the safety cannot be confirmed with respect to the database and which is therefore given such a low data access permission setting that the program can make only limited access that does not cause security problems is still executable by allowing access to a resource based on a low resource access privilege setting. In short, the information processing device is capable of executing a program which is safe, but is not proven to be so.

With the information processing device, the access to the resource by the program becomes controllable by way of the resource access privilege setting which is made based on the data access permission setting by which database access is controllable. Therefore, no control list of resource access by the program needs be made and affixed to the program in advance. Also, the resource access privilege setting is readily made.

Thus, the access to the resource by the program can be controlled flexibly with security taken into account. Resource security thereby improves and better utilization of the resource becomes possible.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a function block diagram schematically showing a configuration of a terminal in accordance with an embodiment of the present invention.

FIG. 2 is a schematic illustration showing, as an example, a network system to which the terminal in FIG. 1 is connected.

FIG. 3 is a schematic illustration showing a data structure of a database in the terminal in FIG. 1.

FIG. 4 is a flow chart showing procedures to make a data access permission setting in the terminal in FIG. 1 when installing a program.

FIG. 5 is a flow chart showing procedures to control access to data by a program in the terminal in FIG. 1.

FIG. 6 is a function block diagram schematically showing a configuration of a terminal in accordance with another embodiment of the present invention.

FIG. 7 is a flow chart showing procedures to alter a resource access privilege setting of a program in the terminal in FIG. 6.

FIG. 8 is a flow chart showing procedures to control access to a resource by a program in the terminal in FIG. 6,

### DESCRIPTION OF THE EMBODIMENTS

[Embodiment 1]

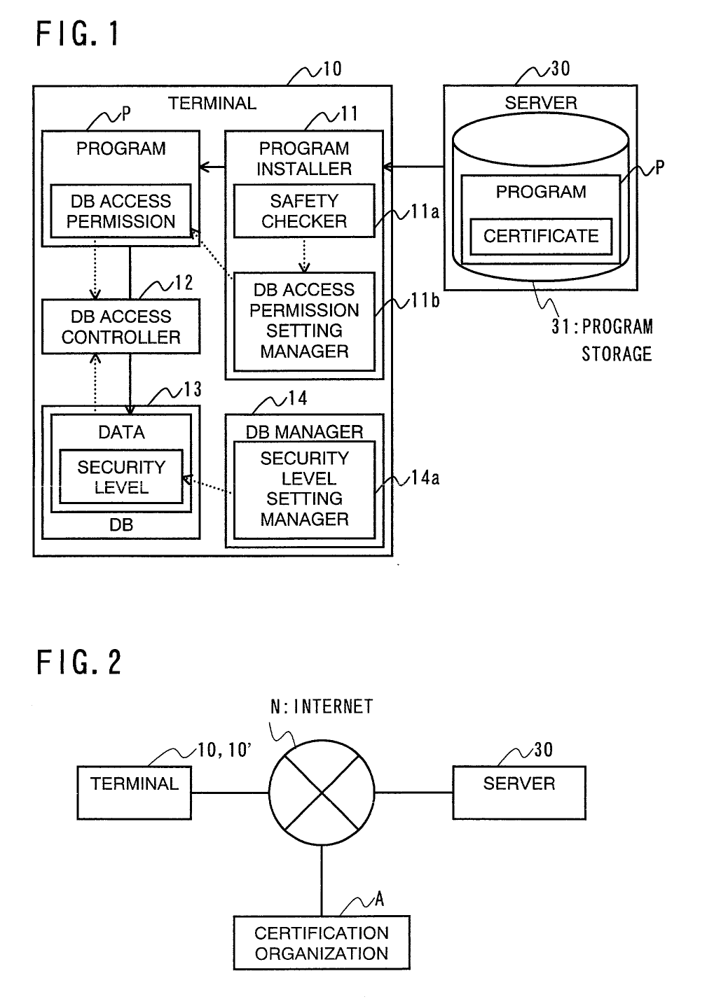

The following will describe an embodiment of the present invention in reference to FIGS. 1 to 5.

A terminal (database device) 10 of the present embodiment is a database device having a function to control access to a database (DB) 13.

FIG. 1 is a function block diagram schematically showing a configuration of a terminal 10. As shown in FIG. 1, the terminal 10 includes a program installer 11, a database access controller 12, a database 13, and a database manager 14. A program P which accesses to the database 13 is installed in the terminal 10.

“Installation” by the program installer 11 is defined here as a process to externally transfer the program P to the terminal 10 so that the program P is executable on the terminal 10. The program installer 11 includes a safety checker 11a for checking the safety of a program P before the installation thereof and a data access permission setting manager lib for making a data access permission setting for the program P with respect to data in the database 13 according to the checked safety level.

The safety checker 11a verifies the safety of the program P with respect to the resource before the externally acquired program P is installed in the terminal 10. The safety of the program P in the terminal 10 can be verified by means of, for example, a certification issued to the program P by a certification organization A (FIG. 2), an affixed signature of a trustworthy program author, or code of the program P in the terminal 10. Accordingly, the safety checker 11a determines that the program P has a high safety level only when, for example, in the presence of a certification or signature.

Based on the checking by the safety checker 11a, the database access permission setting manager lib assigns a “high access permission setting” to a program P of a high safety level, thus allowing the program P to access data of a high security level. In contrast, the database access permission setting manager 11b assigns a “low access permission setting” to a program P of a low safety level, thus denying the program P access to data of a high security level, that is, allowing the program P to access data of a low security level only. The program P records those high or low access permission settings (data access permission information) assigned to the program P by the program installer 11. Alternatively, the data access permission setting may be recorded external to the program P so that the information is associated to the corresponding program P and accessible by the database access controller 12.

The program P is a software program downloaded onto the terminal 10 by the program installer 11. The program P records information on permission to access data in the database 13 (data access permission information) assigned by the database access permission setting manager 11b in accordance with a result of the safety verification performed by the safety checker 11a.

The database 13 records various kinds of information, including information on the terminal 10, the user, etc. so that the program P can read/write. The actual data of the database 13 may be stored in the terminal 10 or alternatively in an external server 30 connected over the Internet N or a like network.

The database manager 14 manages the database 13. Specifically, the database manager 14 includes a security level setting manager 14a for making a security level setting for each set of data in the database 13. The security level setting of data can be made by the user as he/she wants, through the security level setting manager 14a. Alternatively, the security level setting may be automatically made by the security level setting manager 14a when the user or the system creates data. The assigning of a security level setting to each set of data enables flexible access control.

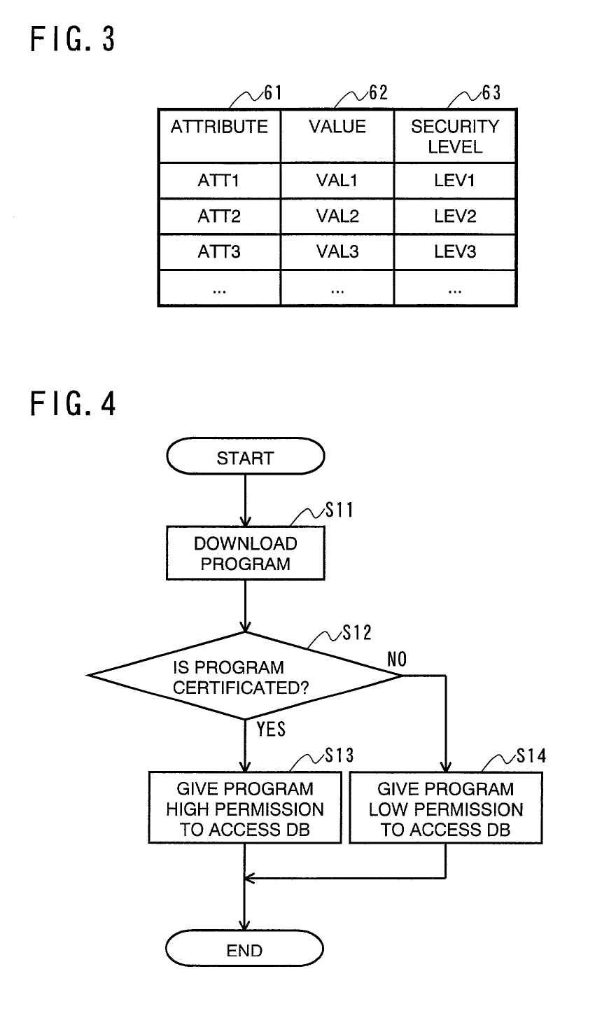

FIG. 3 shows, as an example, the data structure of the database 13 in the terminal 10. Referring to the figure, each set of data in the database 13 includes the following fields: an attribute 61, a content 62, and a security level 63. The attribute 61 records an attribute of the data. The content 62 records a value or values of the data. The security level 63 records a security level setting of the data.

The security level of data is set to either a “high security level setting,” under which no access is permitted to a program P of a low safety level, or a “low security level setting,” under which access is permitted to even programs P of a low safety level, for example. Note that there are no particular limitations on the data structure of the database 13 in terms of the sequence of data, specific data mapping method, so long as each set of data is given an attribute and a security level setting: three different security level settings, in stead of two as in above, may be designed. A security level setting may be assigned to each record, field, or file in a database.

When the program P attempts to gain access to data in the database 13, the database access controller 12 determines whether to allow the access, by comparing the access permission setting of the program P with the security level setting (security level 63) of the data in the database 13. The database access controller 12 allows a program P of a high access permission setting to access data of low and high security level settings and a program P of a low access permission setting to access data of a low security level setting only.

An arrangement may be made so that when the database access controller 12 determines not to allow access as a result of comparison of the data access permission setting with the security level setting, the user can be asked for a command on how to deal with the execution of the program P before proceeding further.

Alternatively, the database access controller 12 may be adapted to alert, using an indicator or the like, the user to any attempt by a program P to gain access to data of a high security level setting in the database 13 during the execution thereof.

FIG. 2 is a schematic illustration showing, as an example, a computer network system of which the terminal 10 is a part. The terminal 10 is connected to the server 30 and the certification organization A over the Internet N as shown in FIG. 2.

The server 30 stores the program P in a program storage 31 for transmission to the terminal 10. Thus, the terminal 10 can download the program P by connecting to the server 30.

The program P is externally transferred by the program installer 11 to the terminal 10. Before installation and execution, the program P is verified by the safety checker 11a as to safety and assigned a data access permission setting by the database access permission setting manager 11b. The program P may be transmitted from the external server 30 over the Internet N or read from a CD-ROM or another storage medium connected to the terminal 10, for example.

Further, as shown in FIG. 1, the program P, before transferred to the terminal 10, may include a certificate, such as a signature of the program author affixed thereto, to authenticate the safety in the terminal 10. If the certificate is encrypted for improved security and recorded in a header or the like of the program P, the safety checker 11a decrypts the information. As would be evident from this, affixing a certificate to the program P makes it easier for the safety checker 11a to verify the safety.

The certification organization A is an organization who guarantees the safety of the program P which is downloaded by the terminal 10 and offers services including the adding of a signature or the like to the program P. There are no limitations on how to add a signature or the like to the program P. The author of the program P may request the certification organization A to add a signature or the like to the program P before storing the program P in the server 30 or store the program P in the server 30 first with no signature or the like before making a request to the server 30 so that the server 30 connects later to the certification organization A to have a signature or the like affixed to the program P. A further alternative is for the author of the program P to affix a signature or the like to his/her program P, using a signature affixing program obtained in advance from the certification organization A.

The server 30 may be regarded as a mere storage site for the program P before the program P is loaded by the terminal 10. In other words, the program P is not necessarily downloaded by the terminal 10 over a network, but may be stored, for example, on a storage device or a CD-ROM in the terminal 10.

The Internet N is used to connect the terminal 10, the server 30, and the certification organization A with one another and acts as a medium to move the program P. An intranet is a possible replacement.

The terminal 10 (10′) can be constructed from a personal computer or other similar general-purpose computer. The server 30 can be constructed from a work station, personal computer, other similar general-purpose computer.

Specifically, the terminal 10 and the server 30 each include a CPU (central processing unit) executing instructions in the program implementing associated functions; a ROM (read only memory) storing a boot logic; a RAM (random access memory) into which the program is loaded; a hard disk or other similar storage device (storage medium) storing the program and various databases; a keyboard, mouse, and other input devices; a monitor, speaker, printer, and other output devices; and a network connecting device which establishes connection to an external network, with all these components interconnected by an internal bus.

Those functions of the terminal 10 and the server 30 are all provided by loading programs from the storage device to the RAM when necessary for execution by the CPU.

Now, referring to the flow chart in FIG. 4, the following will describe an operation whereby the terminal 10 obtains the program P from the server 30 and installs the program P in itself. The operation is applicable when the program P is read from a CD-ROM for installation.

First, in step 11, the program installer 11 connects to the server 30 or carries out a similar process, to download the program P in an area allocated for storage in the terminal 10.

Next, in step 12, the safety checker 11a checks if the downloaded program P is certificated by the certification organization A or carries out a similar process, to verify the safety of the program P. If the program P is certificated, i.e., if the program P has an affixed signature or the like (“YES” in step 12), the operation proceeds to step 13 in which a high access permission setting is assigned to the program P. In contrast, if the program is not certificated, i.e., if the program P has no affixed signature or the like (“NO” in step 12), the operation proceeds to step 14 in which a low access permission setting is assigned to the program P.

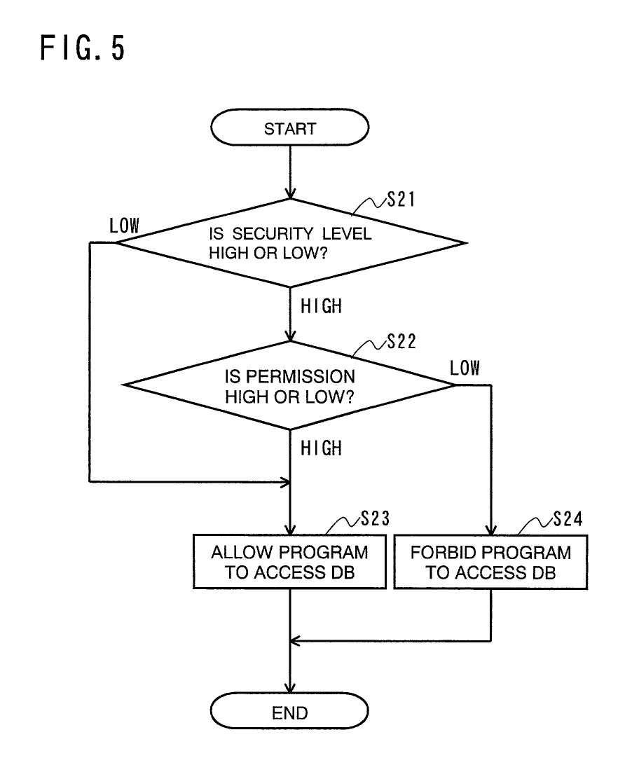

Referring to the flow chart in FIG. 5, the following will describe an operation to control the access to data in the database 13 by the program P.

First, in step 21, the database access controller 12 checks the security level setting assigned to the data in the database 13 to which the program P is seeking access. If the security level setting is low (“LOW” in step 21), the operation proceeds to step 23 in which the program P is allowed access to the data.

In contrast, if the security level setting is high (“HIGH” in step 21), the operation proceeds to step 22 in which the access permission setting of the program P is checked. If the access permission setting is high (“HIGH” in step 22), the operation proceeds to step 23 in which the program P is allowed access to the data. Meanwhile, if the access permission setting of the program P is low (“LOW” in step 22), the operation proceeds to step 24 in which the program P is denied access to the data and an exceptional process is performed.

There are no particular limitations on the exceptional process. Quitting the program P altogether is one example. Alternatively, allow the operation to proceed while keep on denying access to the data. Another possible example is to alert the user to the illegal access so that the user can decide how to deal with the execution of the program P.

As detailed above, in the terminal 10, a security level setting is assigned to each set of data in the database 13, and an access permission setting is assigned to the installed program P with respect to the data in the database 13. Only the program P with a sufficiently high access permission setting is allowed access as a result of the comparison of the access permission setting and the security level setting of the particular set of data to which the program P is seeking access. Thus, the terminal 10 can take account of security and be flexible in controlling the access to the data in the database 13.

In the description above, the terminal 10 uses two data access permission settings (HIGH and LOW) and two security level settings (HIGH and LOW); however, there are no particular limitations on the number of settings. Three or more data access permission settings and security level settings may be used depending on the security levels of the data and the safety of the installed program P.

The data access permission of the program P may be set on a database-by-database basis. Alternatively, a single data access permission setting may be assigned to a plurality of databases or to all the databases in the terminal 10.

[Embodiment 2]

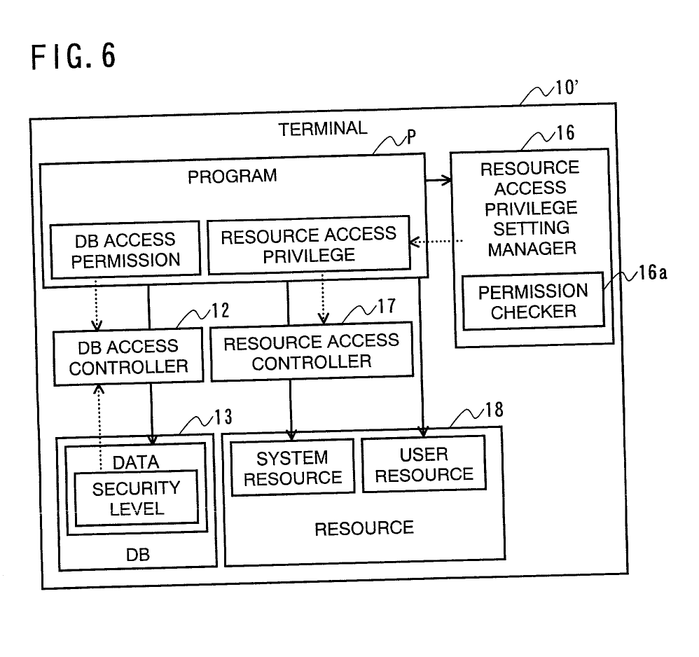

The following will describe another embodiment of the present invention in reference to FIGS. 6 to 8. The terminal 10′ of this embodiment is inclusive of the terminal 10 described in embodiment 1 in reference to FIGS. 1 to 5; common reference numerals are used for these elements and no new description is given here for the terminal 10′. Those terms defined in embodiment 1 are used here as defined therein, unless otherwise mentioned.

The terminal 10 described in embodiment 1 assigns a data access permission setting to a program P installed therein to control access to the data in the database 13 during execution of the program P. Although the terminal 10 ensures security as to the control of access to the data in the database 13, access to other resources in the terminal 10 need to be taken into account to deliver improved security.

In this embodiment, the terminal (information processing device) 10′ will be described which controls access to those resources other than the databases during execution of the program P installed in the terminal 10′ by assigning an access permission setting regarding those resources. The terminal 10′ is an information processing device with an access control function whereby a special access permission setting (execution permission) is assigned to the program P if the program P is safe to the resources in the terminal 10′ and only the programs P having a special access permission setting can access important resources.

FIG. 6 is a function block diagram schematically showing an arrangement of the terminal 10′. As shown in FIG. 6, the terminal 10′ includes a resource access privilege setting manager 16, a resource access controller 17, and resources 18, as well as the program P, the database access controller 12, and the database 13. Although not illustrated in FIG. 6, the terminal 10′ may include a program installer 11 and a database manager 14 (see FIG. 1).

The resource access privilege setting manager 16 assigns a resource access privilege setting to the program P and changes the resource access privilege setting of the program P on a request from the program P. Note that the resource access privilege setting manager 16 includes a permission checker 16a to verify the safety of the program P and determine whether to assign a high resource access privilege setting. Alternatively, the data access permission setting may be recorded external to the program P so that the information is associated to the corresponding program P and accessible by the resources 17.

In the terminal 10′, the resource access privilege setting manager 16 assigns a resource access privilege setting to the program P. The program P records the resource access privilege setting as well as the data access permission setting assigned by the data access permission setting manager 11b (see FIG. 1).

The resources 18 constitute a part of the terminal 10′ and divided into system resources and user resources. As accessed by the program P, the resources 18 are used to utilize functions of the terminal 10′. The system resources are of a high security level setting, while the user resources are of a low security level setting.

Accordingly, we define two resource access privileges for the resource access privilege setting manager 16 to assign to individual resources. A “user privilege” allows access to resources that do not affect the security of the terminal 10′. A “system privilege” allows access to resources that affect the security.

The resource access privilege setting manager 16 sets the resource access privilege to the “user privilege” for all the programs P with no exception at the same time as the data access permission setting manager 11b makes a data access permission setting when the program P is installed into the terminal 10′. Needless to say, similarly to the data access permission settings, the safety of the program P may be verified for the resources so as to set the resource access privilege to the most appropriate value.

As the program P attempts to gain access to a system resource of the resources 18, the resource access controller 17 checks the resource access privilege setting assigned to the program P. If the program P has a system privilege, the resource access controller 17 allows the program P to access the system resource and the user resources; if the program P has a user privilege, the resource access controller 17 allows access to the user resources, but denies access to the system resources.

An arrangement may be made so that if the resource access controller 17 determining not to allow access as a result of the checking of the resource access privilege, the user can be asked for a command on how to deal with the execution of the program P before proceeding further.

Alternatively, the resource access controller 17 may be adapted to alert, using an indicator or the like, the user to any attempt by a program P to gain access to a system resource of the resource 18 during the execution thereof.

With a low resource access privilege setting, the program P cannot be executed in some cases because of the need for a resource access privilege setting that is higher than the actual setting. For example, a process that requires a system privilege is called for during execution of a program P with a user privilege setting.

Such a problem is solved by the terminal 10′ by means of the provision of the resource access privilege setting manager 16 which allows the resource access privilege setting with respect to the resources 18 to be changed based on the data access permission with respect to the data in the database 13. The resource access privilege setting can be changed when there is a request from the program P which runs into a need to change the resource access privilege setting thereof to carry out a certain process.

Specifically, to change the resource access privilege setting of the program P, the resource access privilege setting manager 16 requests a special keyword which is an data item of the database 13. The keyword has a high security level setting affixed thereto and therefore is accessible only by a program P to which a high access permission setting is assigned as a result of the authentication of safety by the program installer 11. Conversely, the program P to which a low access permission setting is assigned cannot access the keyword. The resource access privilege setting manager 16 regards a program P which have successfully accessed and presented a keyword as being a program to which a high access permission setting is assigned, and sets the system privilege accordingly.

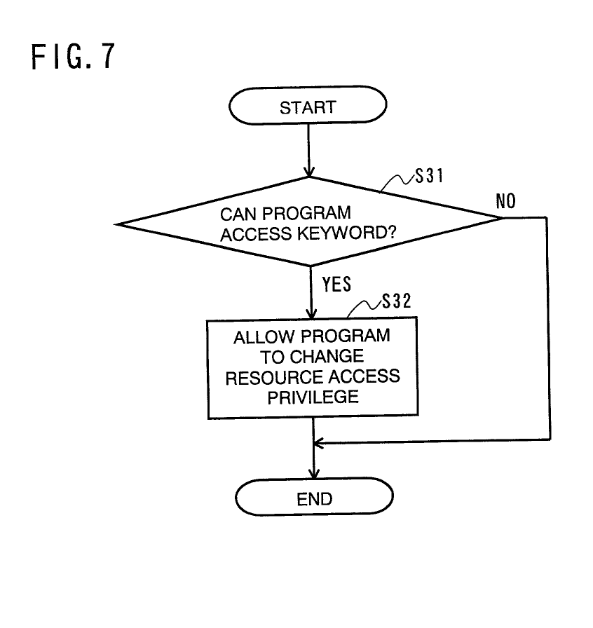

The following will describe an operation to change the resource access privilege setting of the program P in reference to the flow chart in FIG. 7.

First, in step 31, to access a resource that requires the system privilege, a program P whose resource access privilege is set to the user privilege carries out a process whereby the resource access privilege setting is changed. Specifically, the program P first accesses a keyword, which is a data item of the database 13, having a high security level setting affixed thereto and secondly presents the keyword to the resource access privilege setting manager 16 to request a change to the system privilege. Accordingly, in the resource access privilege setting manager 16, upon reception of the request for a change to the system privilege, the permission checker 16a checks the keyword to verify that a high access permission setting is assigned to the program P.

Subsequently, the permission checker 16a determines that the presented keyword is appropriate, that is, the program P has successfully accessed the keyword (“YES” in step 31), the resource access privilege setting manager 16 assigns a system privilege setting to the program P (step 32). Meanwhile, the permission checker 16a determines that the presented keyword is inappropriate (“NO” in step 31), the resource access privilege setting manager 16 does not change the resource access privilege setting.

For example, the keyword, which is an data item of the database 13, is stored in an area in the database 13. The keyword is arranged so that it is accessible only by programs P with a high access permission setting. The program P can acquire a keyword by issuing a system call: for example,

keyword=read_data_from_Database (keywarod ID)

Note that if the program P issuing the system call has a low data access permission setting, the program cannot acquire the keyword.

The program P, having acquired a keyword from the database 13, can by itself change the access privilege setting by issuing a system call: for example,

change_access_mode (“keyword”)

Note that the issuance of the system call does not guarantee a change; if the keyword is inappropriate, the instruction fails and the access permission setting is not changed.

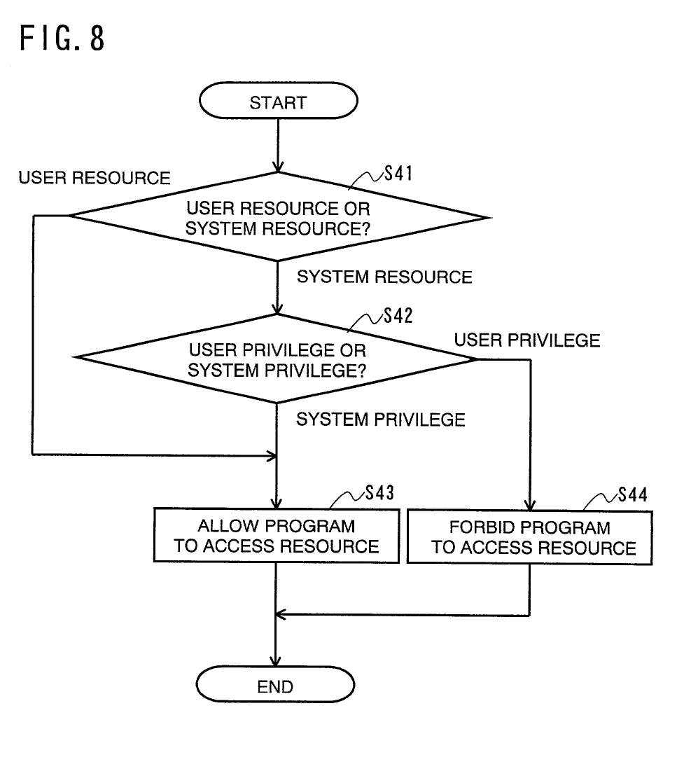

Now, referring to the flow chart in FIG. 8, the following will describe a process to control access to the resources 18 by the program P.

In step 41, the resource access controller 17 checks which resources the program P will access; if the resource 18 accessed by the program P belongs to user resources, that is, those resources that do not affect security (“USER RESOURCE” in step 41), the operation proceeds to step 43 in which the program P is allowed access to the resource.

In contrast, the resource 18 accessed by the program P belongs to system resources, that is, those resources that affect security (“SYSTEM RESOURCE” in step 41), the operation proceeds to step 42 in which the resource access controller 17 checks the resource access privilege setting of the program P. If the resource access privilege setting of the program P is a system privilege (“SYSTEM PRIVILEGE” in step 42), the operation proceeds to step 43 in which the program P is allowed access to the resource. In contrast, if the resource access privilege setting of the program P is a user privilege (“USER PRIVILEGE” in step 42), the operation proceeds to step 44 in which the program P is denied access to the resource and an exceptional process is performed.

There are no particular limitations on the exceptional process. Quitting the program P altogether is one example. Alternatively, allow the operation to proceed while keep on denying access to the resource. Another possible example is to alert the user to the illegal access so that the user can decide how to deal with the execution of the program P.

As detailed above, in the terminal 10′, an access permission setting is assigned to the program P installed in the terminal 10′ with respect to the resources 18. When the program P attempts to gain access to a resource of a high security level, the resource access privilege setting is checked so that only programs P with a sufficiently high access permission setting are allowed such access. Thus, the terminal 10′ can take account of security and be flexible in controlling the access to the resources other than the database.

In the terminal 10′, the program P can by itself carry out an operation dedicated to change the access privilege setting with respect to resources, and a particular data item (keyword), in the database 13, to which a high security level setting is assigned is required for the program P to successfully carry out the privilege-setting-changing operation.

Thus, the program P to which a high access permission setting is assigned with respect to the database 13 accesses the keyword in the database 13 and change by itself the resource access privilege setting to a system privilege. Consequently, the program P can access communications and other important system resources as necessary.

Generally, a program P which is allowed access to important data can be regarded as being safe to allow access to resources of some importance. Accordingly, in the terminal 10′, the safety of the program P with respect to the database is applied to that with respect to other resources to assign the resource access privilege setting. However, in this case, assigning a resource access privilege setting may be forbidden as an exceptional case, if the privilege is related to a resource whose behavior is deeply involved with the operation of hardware and whose error operation can cause a system crash, or otherwise very important resource.

In the terminal 10′, if the process to change the resource access privilege setting includes a process to access to the database 13, the database side (database access controller 12) can determine whether to assign a high resource access privilege setting to the program P, which is essentially equivalent to allowing or denying program P access to the system resource.

Thus, the access to resources by the program P can be controlled in various manners. For example, if the user makes such a temporary setting to hide the content of the keyword from a program P of a high data access permission setting, the program P still fails to acquire the keyword and change the resource access privilege setting. Access to important resources can be exceptionally forbidden. Accordingly, exceptional processes become possible in resource access control without changing the download and execution processes of the program P nor without a process, for example, to force the resource access permission setting of the program P to switch from high to low.

In the description above, the terminal 10′ uses two resource access privilege settings (SYSTEM PRIVILEGE and USER PRIVILEGE) and two resource categories (SYSTEM RESOURCES and USER RESOURCES); however, there are no particular limitations on the number of settings and categories. Three or more resource access privilege settings and resource categories may be used depending on the safety level of the resources and the safety level of the program.

Further, the resource access privilege setting changed to the system privilege may have expiry. Specifically, an arrangement may be made so that the program P is normally assigned the user privilege setting and switched to the system privilege setting during a period when processes that require the system privilege are carried out. Another arrangement may be made so that if the program P is a lower-level program running under an upper-level program, the program P acquires the system privilege only when a request from the upper-level program is processed, by presenting the keyword supplied by the upper-level program as the data access permission to the permission checker 16a.

A dedicated file (database) may be provided to store keywords accessed to verify the data access permission setting of the program P. Further, the dedicated file may store a keyword representative of the resource access privilege required by the program P so that the resource access privilege setting manager 16 determines which privilege settings to assign based on the keyword presented by the program P.

The permission checker 16a may be adapted to verify the data access permission setting assigned to the program P by reading the data access permission setting recorded in the program P with respect to the program P.

As detailed in the foregoing, according to the database access control method for use with the terminal 10′, database access control for a program becomes possible by making a security level setting for a set of data in the database and a data access permission setting for a program. According to the resource access control method for use with the terminal 10′, resource access control becomes possible by means of the aforementioned database access control. Thus, the terminal 10′ can control the database access by the program flexibly, with security taken into account. The database and resource access control methods are suitably applicable to general information terminals to which a program can be installed as, for example, a plug-in program.

The embodiments are by no means intended to limit the scope of the present invention. Various modification and alterations are possible without going beyond the scope of the invention. Some examples are presented in the following.

The database device (terminals 10, 10′) in accordance with the present invention may include:

(1) means for storing a program;

(2) means (safety checker 11a) for checking the safety level setting of the program;

(3) means (data access permission setting manager 11b) for making an access permission setting for a program with respect to data in a database based on the checked safety level;

(4) means for executing the program; and

(5) means (database access controller 12) for, when the program attempts to gain access to a set of data in the database (database 13), determining whether to allow or deny the access by comparing the access permission setting and a security level setting given to that particular set of data. The configuration enables the database device to control access to the database by the program.

The database device in accordance with the present invention may include means (security level setting manager 14a) which allows the user to make a security level setting as he/she likes.

The database device in accordance with the present invention may include:

means (resource access controller 17) for asking the user how to proceed with execution of the program when the program is denied access as a result of the comparison of the access permission setting and the security level setting; and

means (resource access controller 17) for determining how to proceed with execution of the program according to a command input (instruction) from the user.

The database device in accordance with the present invention may be adapted so that the program is given additional information (e.g., signature of the author) in advance which enables the database device to readily check the safety level.

The database device in accordance with the present invention may include means for alerting, using an indicator or the like, the user to any attempt to gain access to a set of data of a high security level setting in the database during the execution of the program.

The information processing device (terminal 10′) in accordance with the present invention may have a system resource and a user resource as the resource; assign the program either a “user privilege” according to which access to the system resource is restricted or a “system privilege” according to which access to the system resource is not restricted as a resource access privilege setting; and include means (resource access privilege setting manager 16) for switching the resource access privilege setting when the program is executed.

The information processing device in accordance with the present invention may perform the switching of the resource access privilege setting based on a keyword stored in the database as a data item of the high security level setting so that the program can gain access only when a high safety level is detected. Thus, utilizing the database access control method for use with the database device, the resource access privilege setting can be switched.

The information processing device in accordance with the present invention may include:

means for asking the user how to proceed with execution of a program if the program without the system privilege as the resource access privilege setting attempts to gain access to the system resource; and

means for determining how to proceed with execution of the program according to a command input from the user.

The information processing device in accordance with the present invention may include means for alerting, using an indicator or the like, the user to any attempt to gain access to the system resource during the execution of the program.

Finally, the present invention may be applied to a stand-alone device (for example, portable computer, word processing device, etc.) or a system made up of multiple devices (for example, host computer, terminal computer, interface device, networking device, reader, printer, etc.).

The objectives of the present invention can be achieved by feeding into a device or system a storage medium which stores, in a computer-readable manner, program code (execution program, intermediate code program, source program) of a database data access control program and a resource access control program which are software implementing the aforementioned functions, and causing a computer (alternatively CPU or MPU) in the device or system to read out and execute the program code stored in the storage medium. In this case, the program code read from the storage medium themselves implements the functions, and the storage medium storing the program code constitutes the present invention.

The storage medium to feed the program code can be adapted to be separable from a system or device. Also, the storage medium may be a medium which holds the program code in fixed manner so that the storage medium can feed the program code. Further, the storage medium may be of such a type that is connected to a system or device so that the stored program code can be directly read out by a computer or of such a type that is connected so as to be readable via a program reader connected to the system or device as an external storage device.

Examples of the storage medium include tapes, such as magnetic tape and cassette tape; disks including magnetic disks, such as floppy disks and hard disk, and optical disks, such as CD-ROMs, MOs, MDs, DVDs, and CD-Rs; cards, such as IC card (including memory cards) and optical cards; and semiconductor memories, such as mask ROMs, EPROMs, EEPROMs, and flash ROMs.

The program code may be stored in such a manner that a computer can read the program code from a storage medium for direct execution or in such a manner that the program code is transferred from a storage medium to a program memory area in a main memory before a computer reads from the main memory for execution.

The system or device may be adapted to be connectable to a communications network (including the Internet, an intranet, etc.) to feed the program code over the communications network.

Note that it is supposed that a program for reading the aforementioned program code from a storage medium for loading into a main memory and a program for downloading the aforementioned program code from the communications network are both stored in advance in a system or device so as to be executable by a computer.

The aforementioned functions can be implemented not only by executing the aforementioned program code read out by a computer, but also by means of, for example, an OS which runs on the computer and entirely or partly executes an actual process based on an instruction in the program code.

The aforementioned functions can be implemented also by means of for example, a CPU which is provided in a function extension board provided in a computer or a function extension unit connected to a computer for entire or partial execution of an actual process based on an instruction in the program code after the program code read from a storage medium is written to a memory in the function extension board or the function extension unit.

As detailed in the foregoing, a database access control method in accordance with the present invention is a database access control method for use with a database device executing a program which accesses a database, and may include the steps of:

making a data access permission setting for the program which accesses the database storing sets of data for each of which a security level setting is made; and

controlling access to the sets of data in the database by the program by determining whether to allow or deny access to each of the sets of data based on the data access permission setting and the security level setting of that set of data when the program attempts to gain access to that set of data.

A database device in accordance with the present invention may include:

data access permission setting manager means for making a data access permission setting for a program which accesses a database storing sets of data for each of which a security level setting is made; and

database access control means for controlling the access to the sets of data in the database by the program by determining whether to allow or deny access to each of the sets of data based on the data access permission setting and the security level setting of that set of data when the program attempts to gain access to that set of data.

According to the method and configuration, in the database in the database device, each set of data is assigned a security level setting, and the program which is executed in the database device to gain access to the database has a data access permission setting with respect to the database. Under these conditions, when the program attempts to gain access to the set of data in the database, the database device compares the security level setting of that set of data with the data access permission setting of the program to determine whether to allow or deny access set by set and thereby control the access to the individual sets data by the program.

Thus, the access to the database by the program can be controlled for each set of data in the database. Therefore, no control list of data access by the program needs to be prepared and affixed to the program in advance.

Thus, the access to the database by the program can be controlled flexibly according to the security level setting of the set of data. In conventional cases, access is denied altogether if the database is overall given a high security level setting because of an important set of data stored therein; however, under the same circumstances, access is not denied in the invention if the program only needs to access a set of data of a low security level setting. In this manner, the database is better utilized as a result of enabling different control of access by the program for each set of data in the database.

A database access control method in accordance with the present invention may further include the step of verifying safety of the program, wherein in the step of making a data access permission setting, the data access permission setting may be made for the program based on a result of the verification in the step of verifying safety of the program.

A database device in accordance with the present invention may further include safety verifier means for verifying safety of the program, wherein the data access permission setting manager means makes the data access permission setting for the program based on a result of the verification by the safety verifier means.

According to the method and configuration, the database device verifies safety of the program which accesses the database, and makes a data access permission setting based on a result of the verification.

Hence, the data access permission setting of the program with respect to the database can be determined according to the verified safety level. Specifically, the data access permission can be set relatively high for a program of which a high safety level is confirmed and relatively low for a program of which a low safety level is confirmed. A program of which the safety cannot be confirmed is still executable by allowing access to the database by means of a low data access permission setting which allows the program such access that will not cause security problems. In short, the database device is capable of executing a program which is safe, but is not proven to be so.

Under these conditions, the verification of safety of the program can be made by way of, for example, the checking of a certification issued by a third party certification organization, the checking of a signature or the like of the author recorded in the program, or the analysis of the program code for checking of operation contents. In short, the database device requires no third party certificate for program safety and therefore is capable of executing a program which is safe, but lacks a certification of a certification organization. Such a program was conventionally inexecutable. In addition, executing such a program requires only a process of collating the security level setting of the set of data with the data access permission setting of the program, which is simpler than in conventional cases.

As detailed in the foregoing, the database device makes it possible to determine whether or not the program is safe and also to allow the program access to the database if it is determined that the program is safe and deny the program access to part of the database when it is determined otherwise. Thus, the access to the database by the program can be controlled flexibly with security taken into account. Consequently, security is improved and the database is better utilized.

A database access control method in accordance with the present invention may be such that the data access permission setting is made for the program by carrying out the step of verifying safety of the program and the step of making a data access permission setting when the program is installed in the database device.

According to the method, moreover, the database device verifies safety of the program which accesses to the database when the program is installed in the device and makes a data access permission setting based on a result of the verification.

As a result, every attempt for the program to gain access to the database in the database device is controllable based on a data access permission setting as detailed in the foregoing. Consequently, security is improved and the database is better utilized.

Note that the present invention can be constituted as a computer-readable storage medium storing a database access control program which controls operations of the database device by causing the computer to carry out each process or causing the computer to provide each means.

According to the configuration, the access to the database by the program executed by the database device is controllable by means of the database access control program read from the storage medium. Thus, those advantages with the aforementioned database access control process or database device are available.

A resource access control method in accordance with the present invention is for use with an information processing device executing a program which accesses a resource in the device, and may include the steps of:

checking a data access permission setting of the program with respect to a database;

making a resource access privilege setting for the program with respect to the resource based on a result of the step of checking a data access permission setting; and

controlling access to the resource by the program by, when the program attempts to gain access to the resource, determining whether to allow or deny the access based on the resource access privilege setting.

An information processing device in accordance with the present invention executes a program which accesses a resource in the device, and may include:

data access permission checker means for checking a data access permission setting of the program with respect to a database;

resource access privilege setting manager means for making a resource access privilege setting for the program with respect to a resource based on a result of the checking by the data access permission setting manager means; and

resource access control means for controlling access to the resource by the program by, when the program attempts to gain access to the resource, determining whether to allow or deny the access based on the resource access privilege setting.

According to the method and configuration, the resource accessing program executed by the information processing device is assigned a resource access privilege setting with respect to a resource, and the information processing device, when the program attempts to gain access to the resource, refers to the resource access privilege setting to determine whether to allow or deny the access and thus control access to the resource by the program. In these circumstances, the information processing device, the program is assigned a data access permission setting with respect to the database, and the resource access privilege setting is made based on this data access permission setting.

Thus, the program can be assigned a resource access privilege setting with respect to the resource based on the data access permission setting which is determined according to the safety level with respect to the database. Specifically, the resource access privilege setting can be set relatively high for a program of which a high safety level is confirmed with respect to the database and relatively low for a program of which a low safety level is confirmed. A program of which the safety cannot be confirmed with respect to the database and which is therefore given such a low data access permission setting that the program can make only limited access that does not cause security problems is still executable by allowing access to a resource by means of a low resource access privilege setting. In short, the information processing device is capable of executing a program which is safe, but is not proven to be so.

With the information processing device, the access to the resource by the program becomes controllable by way of the resource access privilege setting which is made based on the data access permission setting by which database access is controllable. Therefore, no control list of resource access by the program needs be made and affixed to the program in advance. Also, the resource access privilege setting is readily made.

Thus, the access to the resource by the program can be controlled flexibly with security taken into account. Resource security thereby improves and better utilization of the resource becomes possible.

Under these conditions, the data access permission setting of the program may be checked by causing the program to actually access a keyword which is assigned a required security level setting.

The information processing device may use the data access permission setting to compare the security level settings of individual sets of data with the data access permission setting of the program when the program attempts to gain access to the data in the database, to determine whether to allow or deny the access and thus control access to data by the program.

Further, the information processing device may verify safety of the program with respect to the database by, for example, the checking of a certification issued by a third party certification organization, the checking of a signature or the like of the author recorded in the program, or the analysis of the program code for checking of operation contents. In short, the information processing device requires no third party certificate for program safety and therefore is capable of executing a program which is safe, but lacks a certification of a certification organization. Such a program was conventionally inexecutable. In addition, executing such a program requires only a process of collating the security level setting of the set of data with the data access permission setting of the program, which is simpler than in conventional cases.

A resource access control method in accordance with the present invention may be such that the resource access privilege setting of the program is made by carrying out the step of checking a data access permission setting and the step of making a resource access privilege setting when the resource access privilege setting of the program needs an upgrade.

According to the method, the information processing device further checks the data access permission setting of the program and carries out the step of making a resource access privilege setting in response to, for example, an instruction from the program or an operating system when the resource access privilege setting needs an upgrade.

The information processing device can set the resource access privilege of the program to the lowest when the program is installed, and upgrade the resource access privilege setting as appropriate when the resource access privilege setting needs an upgrade to execute the program. Therefore, access can be controlled based on the lowest, but sufficient resource access privilege setting, thereby improving security and better utilizing the resource. The upgraded resource access privilege setting may be given expiry. Specifically, the program is assigned a high resource access privilege setting only when the program requires such a high setting to execute a process and otherwise assigned a low resource access privilege setting.

Note that the present invention can be constituted as a computer-readable storage medium storing a resource access control program which controls operations of the information processing device by causing the computer to carry out each process or causing the computer to provide each means.

According to the configuration, the access to the resource by the program executed by the information processing device is controllable by means of the resource access control program read from the storage medium. Thus, those advantages with the aforementioned resource access control process or information processing device are available.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A database access control method of controlling access to a database in a database device executing a program which accesses a database, comprising the steps of:
(a) making a data access permission setting for the program which accesses the database storing sets of data for each of which a security level setting is made; and
(b) controlling access to the sets of data in the database by the program by determining whether to allow or deny the program access to each of the sets of data based on the data access permission setting and the security level setting of that set of data.

2. The database access control method as set forth in claim 1, further comprising the step of
(c) making a security level setting for the set of data according to an instruction from the user.

3. The database access control method as set forth in claim 1, wherein
step (a) is carried out when the program is installed in the database device.

4. The database access control method as set forth in claim 1, further comprising the step of
(d) verifying safety of the program,
wherein
step (a) is carried out based on a result of step (d).

5. The database access control method as set forth in claim 4, wherein
step (d) is carried out by checking a certification issued by a third party certification organization.

6. The database access control method as set forth in claim 4, wherein
step (d) is carried out by checking additional information recorded in the program.

7. The database access control method as set forth in claim 4, wherein
step (d) is carried out by analyzing code of the program.

8. The database access control method as set forth in claim 4, wherein
the data access permission setting is made for the program by carrying out steps (d) and (a) when the program is installed in the database device.

9. The database access control method as set forth in claim 1, wherein
in step (b), the determination based on the data access permission setting of the program is made by reading out the data access permission setting recorded in the program.

10. The database access control method as set forth in claim 1, wherein
in step (b), the determination is made when the program attempts to gain access to the sets of data.

11. The database access control method as set forth in claim 1, wherein
in step (b), the user is alerted when the program attempts to gain access to a set of data which requires a high data access permission setting.

12. The database access control method as set forth in claim 1, wherein
the program is of a plug-in type.

13. A database device, comprising
data access permission setting manager means for making a data access permission setting for a program which accesses a database storing sets of data for each of which a security level setting is made; and
database access control means for controlling access to the sets of data in the database by the program by determining whether to allow or deny the program access to each of the sets of data based on the data access permission setting and the security level setting of that set of data.

14. The database device as set forth in claim 13, further comprising
security level setting manager means for making a security level setting for the set of data according to an instruction from the user.

15. The database device as set forth in claim 13, wherein
the data access permission setting manager means makes the data access permission setting for the program when the program is installed in the database device.

16. The database device as set forth in claim 13, further comprising
safety verifier means for verifying safety of the program,
wherein
the data access permission setting manager means makes the data access permission setting for the program based on a result of the verification by the safety verifier means.

17. The database device as set forth in claim 16, wherein
the safety verifier means verifies safety of the program by checking a certification issued by a third party certification organization.

18. The database device as set forth in claim 16, wherein
the safety verifier means verifies safety of the program by checking additional information recorded in the program.

19. The database device as set forth in claim 16, wherein
the safety verifier means verifies safety of the program by analyzing code of the program.

20. The database device as set forth in claim 13, wherein
the database access control means makes the determination based on the data access permission setting of the program by reading out the data access permission setting recorded in the program.

21. The database device as set forth in claim 13, wherein
the database access control means determines whether to allow or deny access to each of the sets of data in the database by the program when the program attempts to gain access to the sets of data.

22. The database device as set forth in claim 13, wherein
the database access control means alerts the user when the program attempts to gain access to a set of data which requires a high data access permission setting.

23. The database device as set forth in claim 13, wherein
the program is of a plug-in type.

24. A database access control program to operate the database devices as set forth in any one of claims 13 through 23, wherein
the database access control program causes a computer to function as each of the means.

25. A computer-readable storage medium for storing the database access control program as set forth in claim 24.

26. A resource access control method of controlling access to a resource in an information processing device executing a program which accesses a resource in the device, comprising the steps of:
(a) checking a data access permission setting of the program with respect to a database;
(b) making a resource access privilege setting for the program with respect to the resource based on a result of step (a); and
(c) controlling access to the resource by the program by determining whether to allow or deny the program access to the resource based on the resource access privilege setting.

27. The resource access control method as set forth in claim 26, further comprising the step of
(d) making a data access permission setting for the program with respect to access to data in the database,
wherein
the database stores sets of data for each of which a security level setting is made.

28. The resource access control method as set forth in claim 27, further comprising the step of
(e) making a security level setting for the data according to an instruction from the user.

29. The resource access control method as set forth in claim 27, wherein
step (d) is carried out when the program is installed in the information processing device.

30. The resource access control method as set forth in claim 27, further comprising the step of
(f) verifying safety of the program,
wherein
step (d) is carried out based on a result of step (f).

31. The resource access control method as set forth in claim 30, wherein
step (f) is carried out by checking a certification issued by a third party certification organization.

32. The resource access control method as set forth in claim 30, wherein
step (f) is carried out by checking additional information recorded in the program.

33. The resource access control method as set forth in claim 30, wherein
step (f) is carried out by analyzing code of the program.

34. The resource access control method as set forth in claim 26, wherein
step (a) is carried out by causing the program to actually access such a set of data in the database that has a security level setting required to access the resource.

35. The resource access control method as set forth in claim 26, wherein
step (a) is carried out by reading out the data access permission setting recorded in the program.

36. The resource access control method as set forth in claim 26, wherein
step (a) and step (b) are carried out when the resource access privilege setting of the program needs an upgrade.

37. The resource access control method as set forth in claim 26, wherein
step (b) is carried out when the program is installed in the information processing device, so as to set the resource access privilege of the program to the lowest.

38. The resource access control method as set forth in claim 26, wherein
In step (b), the resource access privilege setting has expiry.

39. The resource access control method as set forth in claim 26, wherein
in step (b), the user is alerted when a high resource access privilege setting is made for the program.

40. The resource access control method as set forth in claim 26, wherein
step (c) is carried out when the program attempts to gain access to the resource.

41. The resource access control method as set forth in claim 26, wherein
in step (c), the user is asked how to proceed with execution of the program, when the program attempts to gain access without a required resource access privilege setting, so as to control the execution of the program according to an instruction from the user.

42. The resource access control method as set forth in claim 26, wherein
in step (c), the user is alerted when the program attempts to gain access to a resource which requires a high resource access privilege setting.

43. The resource access control method as set forth in claim 26, wherein
the program is of a plug-in type.

44. An information processing device for executing a program which accesses a resource in the device, comprising:
data access permission checker means for checking a data access permission setting of the program with respect to a database;
resource access privilege setting manager means for making a resource access privilege setting for the program with respect to the resource based on a result of the checking; and
resource access control means for controlling access to the resource by the program by determining whether to allow or deny the program access to the resource based on the resource access privilege setting.

45. The information processing device as set forth in claim 44, further comprising
data access permission setting manager means for making a data access permission setting for the program with respect to access to data in the database,
wherein
the database stores sets of data for each of which a security level setting is made.

46. The information processing device as set forth in claim 45, further comprising
security level setting manager means for making a security level setting for the data according to an instruction from the user.

47. The information processing device as set forth in claim 45, wherein
the data access permission setting manager means makes the data access permission setting for the program when the program is installed in the information processing device.

48. The information processing device as set forth in claim 45, further comprising
safety verifier means for verifying safety of the program,
wherein
the data access permission setting manager means makes the data access permission setting for the program based on a result of the verification by the safety verifier means.

49. The information processing device as set forth in claim 48, wherein
the safety verifier means verifies safety of the program by checking a certification issued by a third party certification organization.

50. The information processing device as set forth in claim 48, wherein
the safety verifier means verifies safety of the program by checking additional information recorded in the program.

51. The information processing device as set forth in claim 48, wherein
the safety verifier means verifies safety of the program by analyzing code of the program.

52. The information processing device as set forth in claim 44, wherein
the data access permission checker means checks the data access permission setting of the program by causing the program to actually access such a set of data in the database that has a security level setting required to access the resource.

53. The information processing device as set forth in claim 44, wherein
the data access permission checker means checks the data access permission setting of the program by reading out the data access permission setting recorded in the program.

54. The information processing device as set forth in claim 44, wherein
when the resource access privilege setting of the program needs an upgrade, the data access permission checker means checks the data access permission setting of the program, and the resource access privilege setting manager means changes the resource access privilege setting of the program based on a result of the checking.

55. The information processing device as set forth in claim 44, wherein
the resource access privilege setting manager means sets the resource access privilege of the program to the lowest when the program is installed in the information processing device.

56. The information processing device as set forth in claim 44, wherein
when the resource access privilege setting manager means makes the resource access privilege setting for the program, the resource access privilege setting manager means specifies expiry for the resource access privilege setting.

57. The information processing device as set forth in claim 44, wherein
when the resource access privilege setting manager means makes a high resource access privilege setting for the program, the resource access privilege setting manager means alerts the user.

58. The information processing device as set forth in claim 44, wherein
the resource access control means determines whether to allow or deny the program access to the resource when the program attempts to gain access to the resource.

59. The information processing device as set forth in claim 44, wherein
when the program attempts to gain access without a required resource access privilege setting, the resource access control means asks the user how to proceed with execution of the program and controls the execution of the program according to an instruction from the user.

60. The information processing device as set forth in claim 44, wherein
the resource access control means alerts the user when the program attempts to gain access to a resource which requires a high resource access privilege setting.

61. The information processing device as set forth in claim 44, wherein
the program is of a plug-in type.

62. A resource access control program to operate the information processing device as set forth in any one of claims 44 through 61, wherein
the resource access control program causes a computer to function as each of the means.

63. A computer-readable storage medium for storing the resource access control program as set forth in claim 62.
